(19) United States
(12) Patent Application Publication
(10) Pub. No.: US 2011/0013059 A1
(43) Pub. Date: Jan. 20, 2011

(54) IMAGE PICKUP UNIT

(75) Inventors: Mikio NAKAMURA, Tokyo (JP); Tsutomu NAKAMURA, Kamiina-gun (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/835,151

(22) Filed: Jul. 13, 2010

(30) Foreign Application Priority Data
Jul. 15, 2009 (JP) JP2009-166604

(51) Int. Cl. H04N 5/335

(52) U.S. Cl. 348/294; 348/E05.091

(57) ABSTRACT

An image pickup unit having a lens barrel for an optical system includes an electrode which is formed on at least two of a one end portion of the lens barrel, the other end portion of the lens barrel, and a trunk portion of the lens barrel, a wire portion which connects the electrodes electrically, an image pickup element which is provided on one of the one end portion and the other end portion, a plurality of functional elements which is provided to the lens barrel, and a multiplexed-signal converting element which converts multiplexed signal from a plurality of external electrodes provided to the lens barrel. The wire portion transmits signals between the image pickup element and the plurality of functional elements, and the multiplexed-signal converting element.

### CROSS-REFERENCE TO RELATED APPLICATION

The present application is based upon and claims the benefit of priority from the prior Japanese Patent Application No. 2009-166604 filed on Jul. 15, 2009; the entire contents of which are incorporated herein by reference.

### BACKGROUND OF THE INVENTION

1. Field of the Invention

The present invention relates to an image pickup unit, and in particular, to a small-size image pickup unit.

2. Description of the Related Art

In an image pickup unit such as a small-size image pickup unit, which is to be accommodated in a front end of an endoscope, more functionality such as a zooming function, an auto focus function (AF), and mounting of a front-end lighting member has hitherto been sought. However, a diameter of the endoscope being restricted, it has been difficult to secure a space for a signal line and a power supply line for having more functionality.

As a small-size image pickup apparatus, structures proposed in Japanese Patent Application Laid-open Publication Nos. 2001-245186 and 2008-172693 have been known. FIG. 7 shows a schematic structure of a conventional image pickup apparatus described in Japanese Patent Application Laid-open Publication No. 2001-245186. In this case, a lens 802 is installed on a cylindrical shaped trunk portion 801B of a three-dimensional printed circuit board 801. Moreover, a wiring pattern is formed on a leg portion 801A and a semiconductor image pickup element 804 is installed. An optical filter 803 is provided on an upper portion of the semiconductor image pickup element 804.

FIG. 8 shows a schematic structure of a conventional image pickup unit described in Japanese Patent Application Laid-open Publication No. 2008-172693. An image pickup unit 900 described in Japanese Patent Application Laid-open Publication No. 2008-172693 has an electrode which is formed on at least two of a one end portion of a lens barrel 910, the other end portion of the lens barrel 910, and a trunk portion of the lens barrel 910, a wire portion which connects the electrodes electrically, and a functional element and an image pickup element provided near one end portion or both end portions, and the trunk portion of the lens barrel, and by wiring of such electrodes, a small-size image pickup unit is realized without having a need of a separate wiring cable.

### SUMMARY OF THE INVENTION

An image pickup unit according to the present invention, having a lens barrel for an optical system, includes an electrode which is formed on at least two of a one end portion of the lens barrel, the other end portion of the lens barrel, and a trunk portion of the lens barrel, a wire portion which connects the electrodes electrically, an image pickup element which is provided on one of the one end portion and the other end portion, a plurality of functional elements which is provided to the lens barrel, and a multiplexed-signal converting element which converts multiplexed signals from a plurality of external electrodes provided to the lens barrel, and the wire portion transmits signals between the image pickup element and the plurality of functional elements, and the multiplexed-signal converting element.

### BRIEF DESCRIPTION OF THE DRAWINGS

FIG. 1 is a side view showing a schematic structure of an image pickup unit according to a first embodiment;

FIG. 2 is a cross-sectional view showing an internal structure of the image pickup unit according to the first embodiment;

FIG. 3 is a cross-sectional view showing an internal structure of an image pickup unit according to a second embodiment;

FIG. 4 is a perspective view showing an arrangement of an image pickup element and a multiplexed-signal converting element on a substrate;

FIG. 5 is a cross-sectional view showing an internal structure of an image pickup unit according to a third embodiment;

FIG. 6 is a perspective view showing an arrangement of a logic circuit section of the image pickup element and the multiplexed-signal converting element on the substrate, and an arrangement of a drive circuit section of the multiplexed-signal converting element, on the substrate;

FIG. 7 is a diagram showing a schematic structure of a conventional image pickup apparatus; and

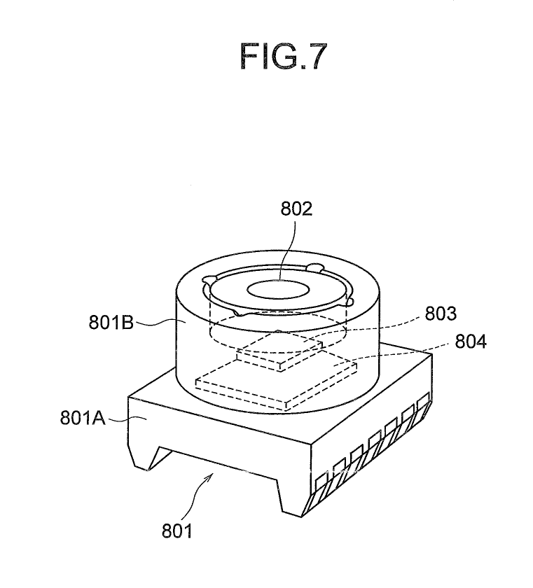

FIG. 8 is a diagram showing a schematic structure of a conventional image pickup unit.

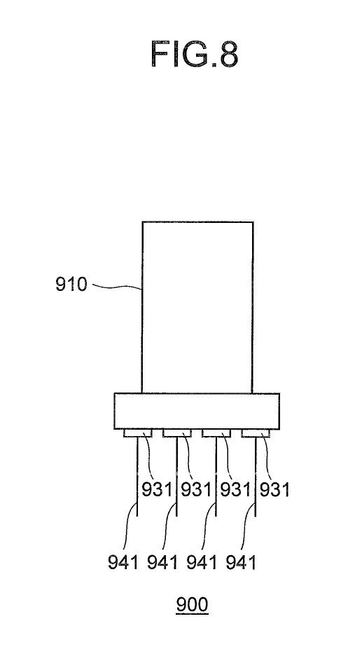

### DETAILED DESCRIPTION OF THE PREFERRED EMBODIMENTS

Exemplary embodiments of an image pickup unit according to the present invention will be described below in detail by referring to the accompanying diagrams. However, the present invention is not restricted to the embodiments described below.

### First Embodiment

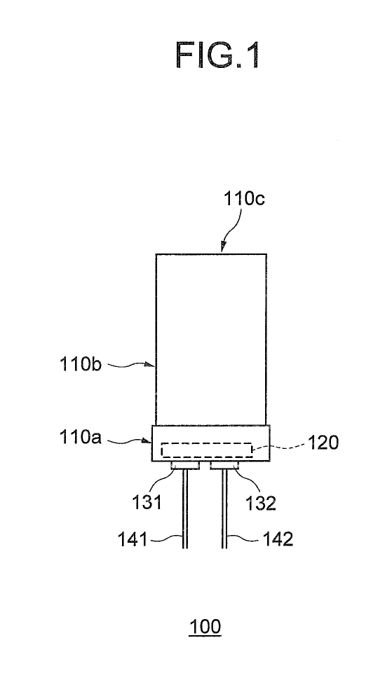

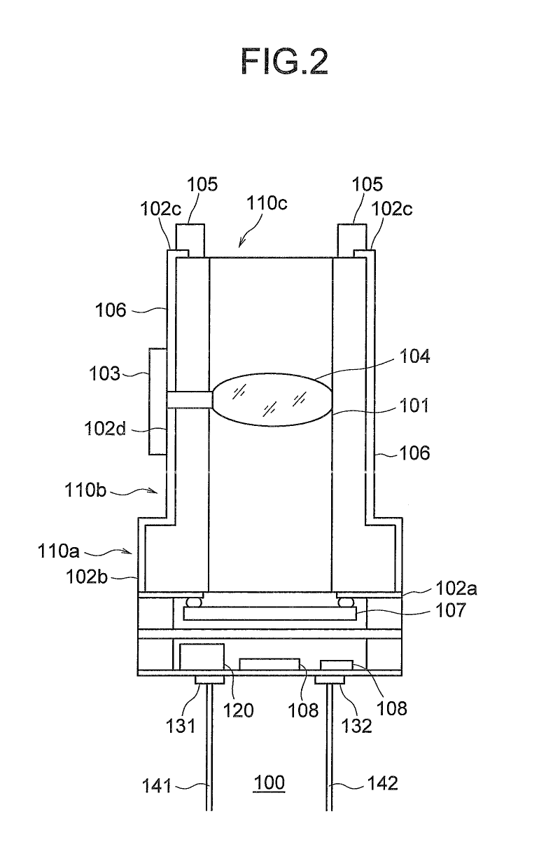

An image pickup unit 100 according to a first embodiment will be described below by referring to FIG. 1 and FIG. 2. FIG. 1 is a side view showing a schematic structure of the image pickup unit 100. FIG. 2 is a cross-sectional view showing an internal structure of the image pickup unit 100.

In FIG. 1, a structure in detail of a lens barrel 101 is omitted.

The image pickup unit 100 includes the lens barrel 101 for an optical system. The lens barrel 101 includes a one end portion 110a, a trunk portion 110b, and the other end portion 110c disposed in order from an image pickup element 107 toward a light emitting element 105.

The one end portion 110a is one end in an axial direction of the lens barrel 101 and proximity thereof, and the other end portion 110c is the other end in the axial direction of the lens barrel 101 and proximity thereof. The trunk portion 110b is a portion of the lens barrel 101 between the one end portion 110a and the other end portion 110c.

A first electrode 102a and a second electrode 102b are provided to the one end portion 110a of the lens barrel 101. A third electrode 102c is provided to the other end portion 110c of the lens barrel 101. Moreover, a fourth electrode 102d is provided to the trunk portion 110b of the lens barrel 101.

When the electrodes are formed (one each) on at least two of the first end portion 110a, the second end portion 110c of the lens barrel 101, and the trunk portion 110b of the lens barrel 101, the electrodes can be disposed arbitrarily.

The first electrode 102a, the second electrode 102b, the third electrode 102c, and the fourth electrode 102d (hereinafter, also called as ‘the four electrodes’) are mutually connected electrically by a wire portion 106 which is provided on an outer peripheral surface of the lens barrel 101.

As shown in FIG. 2, the wire portion 106 is formed by a printing technology on the outer peripheral surface of the lens barrel 101.

By forming the four electrodes and the wire portion 106 is such manner, even when electrical functional elements such as the light emitting element 105 and a drive element 103 are mounted newly on the lens barrel 101, it is not necessary to use a connecting member such as a cable for transmission of signals and supply of power to the functional elements.

Moreover, the image pickup element 107 (such as a CCD (charge coupled device) and a CMOS (complementary metal oxide semiconductor)) is provided to the one end portion 110a of the lens barrel 101. The image pickup element 107 is connected to the first electrode 102a.

On the other hand, the image pickup element 107, an electric circuit member 108, and a multiplexed-signal converting element 120 are connected to the second electrode 102b.

Moreover, the light emitting element 105 is connected to the third electrode 102c. The light emitting element 105 is an element such as an LED (light emitting diode).

The light emitting element 105 emits light to illuminate a surface of an object (not shown in the diagram). Light reflected from the object is formed as an image on an image pickup surface of the image pickup element 107 by a lens 104. The light emitting element 105, the drive element 103, and the image pickup element 107 are driven and controlled by signals from the electric circuit member 108.

Furthermore, the drive element 103 is disposed on the trunk portion 110b, and the drive element 103 is connected to the fourth electrode 102d. The drive element 103 is a motor for zooming drive of the lens 104 and a motor for driving an aperture diaphragm (not shown in the diagram).

In this case, the drive element 103 and the light emitting element 105 are functional elements. The wire portion 106 transmits signals between the image pickup element 107 and the plurality of functional elements.

The electric circuit member 108 transmits signals between elements apart from the image pickup element 107, namely the drive element 103, the light emitting element 105, and other functional elements provided to the lens barrel 101, and the multiplexed-signal converting element 120.

A plurality of external electrodes 131 and 132 are connected to the multiplexed-signal converting element 120. Signal wires 141 and 142 are connected to the external electrodes 131 and 132 respectively. The signal wires 141 and 142 are used for transmitting signals for driving and controlling the functional elements and the image pickup element 107.

The multiplexed-signal converting element 120 is connected to the second electrode 102b. Consequently, the multiplexed-signal converting element 120 is capable of transmitting signals between the image pickup element 107 and various functional elements via the wire portion 106.

The number of external electrodes and signal wires can be set arbitrarily according to specifications of the functional elements and the image pickup element 107. Moreover, the multiplexed-signal converting element 120 can be disposed at an arbitrary position according to arrangement of the functional elements and the image pickup element 107.

Multiplexed signals from the plurality of external electrodes 131 and 132 are input to the multiplexed-signal converting element 120. The multiplexed-signal converting element 120 converts the multiplexed signals that are input, to signals for driving the image pickup element 107 and the plurality of functional elements, and outputs the signals upon converting.

In an arrangement in which, the multiplexed-signal converting element 120 is connected to the second electrode 102b of the one end portion 110a of the lens barrel 101, the multiplexed-signal converting element 120 can be connected to at least one of the image pickup element 107 and the functional elements via the wire portion 106 on the lens barrel 101. Therefore, it is possible to realize a small-size image pickup unit in which, a space for wiring cables to be connected to the image pickup unit 100 is reduced.

### Second Embodiment

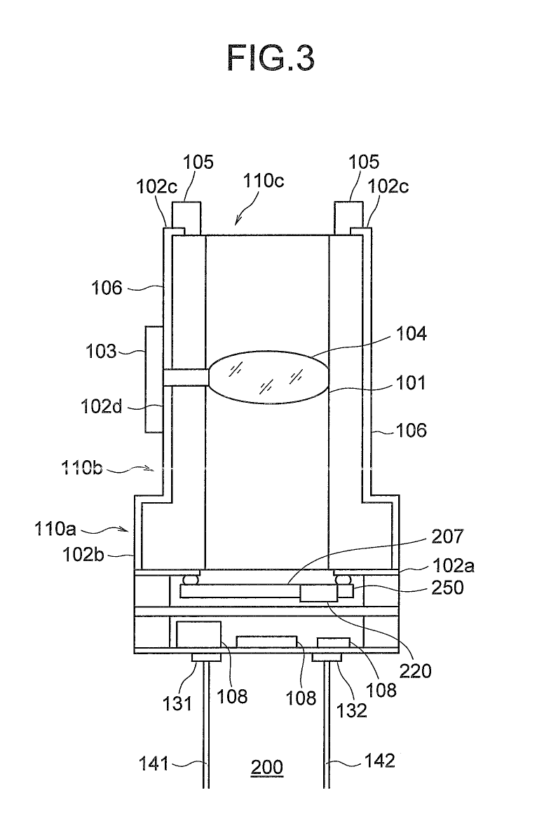

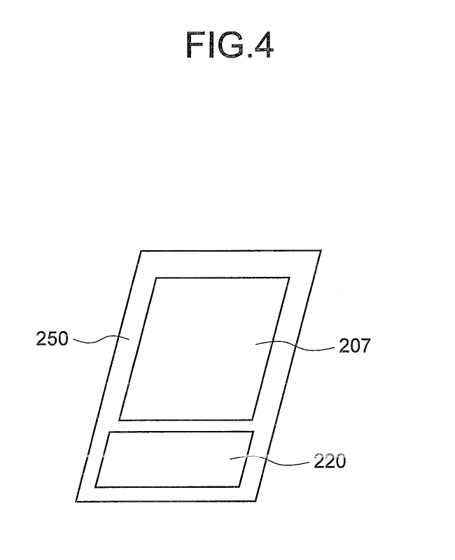

Next, an image pickup unit 200 according to a second embodiment will be described below while referring to FIG. 3 and FIG. 4. FIG. 3 is a cross-sectional view showing an internal structure of the image pickup unit 200. FIG. 4 is a perspective view showing an arrangement of an image pickup element 207 and a multiplexed-signal converting element 220 on a substrate 250.

In the image pickup unit 200 according to the second embodiment, a point that the multiplexed-signal converting element 220 is disposed on the substrate 250 (semiconductor substrate) provided with the image pickup element 207 differs from the image pickup unit 100 according to the first embodiment. The rest of the structure being similar to the structure of the image pickup unit 100 according to the first embodiment, same reference numerals are assigned to members which are same as in the first embodiment, and the description in detail of such elements is omitted.

An arrangement of the image pickup element 207 and the multiplexed-signal converting element 220 on the substrate 220 can be determined arbitrarily according to an arrangement of the first electrode 102a and the second electrode 102b, and an arrangement of the functional elements with respect to the lens barrel 101.

The external wires 131 and 132, similarly as in the image pickup unit 100, are connected to the multiplexed-signal converting element 220, and furthermore, the multiplexed-signal converting element 220 is connected to the second electrode 102b. Accordingly, the multiplexed-signal converting element 220 can be connected to at least one of the image pickup element 207 and the functional element via the wire portion 106. Therefore, it is possible to realize a small-size image pickup unit in which, a space for wiring cables to be connected to the image pickup unit 200 is reduced.

Furthermore, since it is possible to reduce circuit components except the image pickup element 207, it is possible to make the image pickup unit further smaller in size.

The rest of the structure, action, and effect are similar as in the first embodiment.

### Third Embodiment

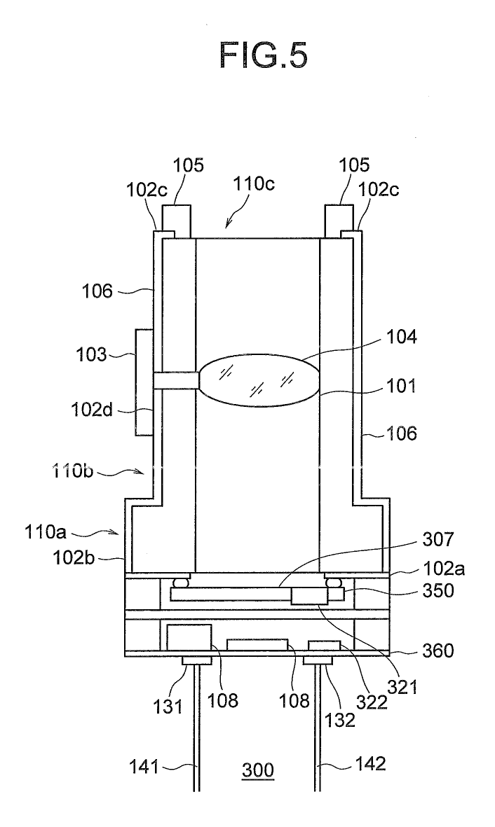

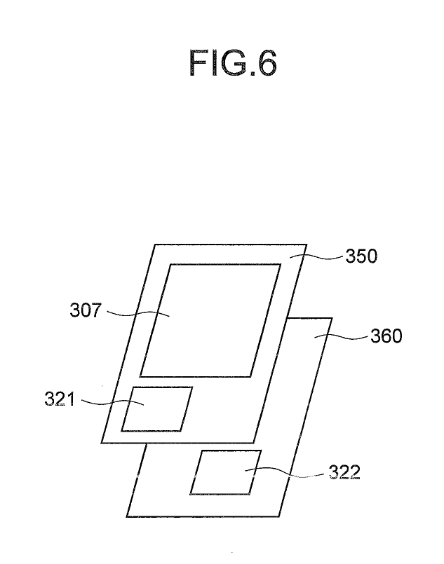

Next, an image pickup unit 300 according to a third embodiment will be described below while referring to FIG. 5 and FIG. 6. FIG. 5 is a cross-sectional view showing an internal structure of the image pickup unit 300. FIG. 6 is a perspective view showing an arrangement of a logic circuit section 321 of an image pickup element 307 and a multiplexed-signal converting element on a substrate 350, and an arrangement of a drive circuit section 322 of a multiplexed-signal converting element on a substrate 360. In FIG. 6, the electric circuit member 108 is omitted.

In the image pickup unit 300 according to the third embodiment, a point that the multiplexed-signal converting element is divided into the logic circuit section 321 and the drive circuit section 322, and the logic circuit section 321 and the drive circuit section 322 are disposed at thermally isolated positions differs from the image pickup unit 100 according to the first embodiment. The rest of the structure being similar to the image pickup unit 100 according to the first embodiment, same reference numerals are assigned to members which are same as in the first embodiment, and the detailed description of such members is omitted.

The logic circuit section 321 (such as a low-voltage logic circuit) is formed on the substrate 350 (semiconductor substrate) same as the image pickup element 307, or in other words, near the image pickup element 307. The drive circuit section 322 (such as a power supply circuit) which is a components provided separately from the logic circuit section 321, and which is for driving the functional elements is formed on the substrate 360 (semiconductor substrate) which is provided separately from the substrate 350. The electric circuit member 108 is formed on the substrate 360.

The logic circuit section 321 and the drive circuit section 322 are connected electrically but are isolated thermally as the substrate 350 and the substrate 360 are disposed to be isolated.

An arrangement of the image pickup element 307 and the logic circuit section 321 on the substrate 350 and an arrangement of the electric circuit member 108 and the drive circuit section 322 on the substrate 322 can be determined arbitrarily according to an arrangement of the first electrode 102a and the second electrode 102b, and an arrangement of the functional elements with respect to the lens barrel 101, provided that the logic circuit section 321 and the drive circuit section 322 are isolated thermally.

The external electrodes 131 and 132 are connected to the drive circuit section 322, and the second electrode 102b is connected to the logic circuit section 321. Accordingly, the multiplexed-signal converting element which is made of the logic circuit section 321 and the drive circuit section 322 can be connected to at least one of the image pickup element 307 and the functional element via the wire portion 106. Therefore, it is possible to realize a small-size image pickup unit in which, a space for wiring cables to be connected to the image pickup unit 300 is reduced.

Furthermore, according to the structure described above, the drive circuit section 322 which is susceptible to release heat and electrical noise can be separated from the image pickup element 307 which is weak against heat and electrical noise. Consequently, it is possible to realize an image pickup unit which produces a favorable image while maintaining the small size of the image pickup unit 300.

Rest of the structure, action, and effect are similar as in the first embodiment.

As it has been described above, the image pickup unit according to the present invention is suitable for a small-size image pickup unit.

The image pickup unit according to the present invention shows an effect that it is possible to realize high performance without increasing an outer shape, particularly a diameter.

What is claimed is:

1. An image pickup unit having a lens barrel for an optical system, comprising:
an electrode which is formed on at least two of a one end portion of the lens barrel, the other end portion of the lens barrel, and a trunk portion of the lens barrel;
a wire portion which connects the electrodes electrically;
an image pickup element which is provided on one of the one end portion and the other end portion;
a plurality of functional elements which is provided to the lens barrel; and
a multiplexed-signal converting element which converts multiplexed signals from a plurality of external electrodes provided to the lens barrel, wherein
the wire portion transmits signals between the image pickup element and the plurality of functional elements, and the multiplexed-signal converting element.

2. The image pickup unit according to claim 1, wherein the multiplexed-signal converting element is provided near the image pickup element.

3. The image pickup unit according to claim 2, wherein the multiplexed-signal converting element is provided on a substrate on which, the image pickup element is provided.

4. The image pickup unit according to claim 1, wherein the multiplexed-signal converting element includes a logic circuit section and a drive circuit section which are disposed upon isolating mutually inside the lens barrel.

5. The image pickup unit according to claim 4, wherein the logic circuit section and the drive circuit section are provided on a separate substrate from the plurality of substrates on which one of the image pickup element and the plurality of functional elements is provided.
